(19) United States
(12) Patent Application Publication
(10) Pub. No.: US 2007/0143997 A1
(43) Pub. Date: Jun. 28, 2007

(54) Crankshaft comprising a combined gear wheel and method for the production and use of said crankshaft

(75) Inventors: Thomas Behr, Elchingen (DE); Uwe Rohrberg, Weinstadt (DE); Tilmann Haug, Weissenhorn (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 10/573,273

(22) PCT Filed: Aug. 23, 2004
(86) PCT No.: PCT/EP04/09387

§ 371 Date: Dec. 18, 2006

(30) Foreign Application Priority Data
Sep. 23, 2003 (DE) 103 44 073.9

(51) Int. Cl. B23P 17/00; F16C 3/04; C21D 5/00; F16C 11/00; C21D 6/00

(52) U.S. Cl. 29/888.08; 148/545; 148/663; 74/596

(57) ABSTRACT

Motors with high power densities and ignition pressures, for example diesel motors, require crankshafts with combined gear wheels, which can withstand high stresses, especially in their connection areas. As a consequence, forged steel crankshafts, to which tempered gear wheels are fixed by means of screws or welding, are usually employed. The aim of the invention is to provide a method comprising fewer method steps for producing a crankshaft with a combined gear wheel and to provide a crankshaft that has been produced according to said method. To achieve this, the crankshaft comprising the combined gear wheel is cast in one piece. Tempered ductile iron is used as the starting material. The strength and wear resistance is increased locally by peening, or by the application of coatings containing carbide.

### CROSS REFERENCE TO RELATED APPLICATION

This application is a national stage of PCT/EP2004/009387 filed Aug. 23, 2004 and based upon DE 103 44 073.9 filed Sep. 23, 2003 under the International Convention.

### BACKGROUND OF THE INVENTION

1. Field of the Invention

The invention concerns a crankshaft with combined gear wheel as well as a process for its production and its use. A crankshaft of this general type is already known from DE19517506A1.

Motors with a high power density and ignition pressure, for example diesel engines, require crankshafts with combined gear wheels, which are subjected to high loads, particularly in the areas in which they are joined. For this reason forged steel crankshafts are generally employed, to which hardened gear wheels are joined by material joining (welding), form-fitting engagement (screwing) or by interference fit.

2. Description of Related Art

Thus, for example, in accordance with DE19517506A1, the gear wheel is screwed on to the crankshaft.

Increased load bearing capacity of crankshafts can also be achieved in accordance with JP59129730A by tempering of the shaft and further processing steps.

The number of the processing steps for manufacturing a crankshaft with combined drive gear wheel requires comparatively lengthy manufacturing times, which drives up costs.

### SUMMARY OF THE INVENTION

The task of the present invention is thus comprised therein, of providing a process with fewer process steps for manufacturing a crankshaft with combined drive gear, as well as the crankshaft resulting therefrom.

With regard to the crankshaft to be provided, the task is inventively solved thereby, that the crankshaft together with the combined gear wheel is cast as a single piece.

The advantage of this arrangement is comprised in the low manufacturing cost as a consequence of the omission of the joining step, as well as the short time required for casting in comparison to forging. Beyond this, in the case of casting, there exists a higher degree of freedom of design.

It is particularly advantageous when the crankshaft with combined drive gear is comprised of tempered ductile iron (ADI). This is a cast iron with spherical graphite which, by targeted thermal treatment (tempering,) among other things, exhibits improved wear characteristics.

Advantages include on the one hand the reduced weight—ADI has approximately a 10% lower weight than the conventionally employed steel. On the other hand ADI exhibits excellent thermal and mechanical characteristics, in particular high strength up to 1600 N/mm².

Due to these positive characteristics of the ADI material one can completely dispense with the conventionally required step of hardening of the gear wheel.

In one particularly advantageous embodiment the area of the gear wheel exhibits a higher hardness relative to the rest of the cast part. This can be accomplished by suitable differentially controlled temperature exposure during the thermal treatment of the different cast partial areas. One further or alternative increasing of the hardness is possible by a cold hardening (so called shot blasting or peening).

A further additional or alternative possibility for localized increasing the hardness of the cast part, for example the teeth, is comprised therein, of locally introducing carbide into the melt. This can occur using carbide-containing coatings or finishings. Thereby one obtains an ADI microstructure with supplemental introduced carbides (so called carbidic ADI=CADI). The thus hardened areas exhibit an increased resistance to wear.

The task with regard to the process to be provided for production of a crankshaft is inventively solved thereby, that the crankshaft is cast as one piece in combination with the drive gear wheel.

It is particularly advantageous when, for casting, base alloys are employed which are suitable for final tempering or annealing. Thereby the crankshaft with combined drive gear can first be cast in the final or completed form, and thereafter be tempered (thermal treatment), whereby the advantageous mechanical and thermal characteristics of the ADI (tempered ductile iron) come to exist. Alternatively, the thermal treatment could also occur directly subsequently to casting, and a possibly use-specific final processing could follow thereafter.

Also advantageous is the hardening of partial areas of the cast part, for example the teeth. This can be accomplished by local differential control of the thermal treatment and/or local cold processing, for example by hardening peening, and/or local introduction of carbide containing layers in the cast shape.

Particularly advantageously the inventive process can be employed in conjunction with die-cast or mold-casting (permanent molds). Thereby, on the one hand, the gear areas can be cast particularly true-to-shape and, on the other hand, an at least partial thermal treatment of the cast shape is possible.

Particularly advantageous is the use of the inventive crankshaft with combined drive gear wheel in a diesel powered vehicle, since these engines are subjected to particularly high loads.

The inventive crankshaft with combined drive gear wheel has demonstrated itself to be particularly suited for use in automobiles. They can however also be employed advantageously in other applications in which they are subjected to high loads. For example, one could mention marine and aviation engineering, as well as stationary applications such as generators.

1-2. (canceled)

3. A process according to claim 2, wherein it involves chill molding or chill casting.

4. A diesel powered vehicle, wherein the diesel engine includes a crankshaft with combined drive gear wheel, wherein both the crankshaft and drive gear wheel are cast as one piece, wherein crankshaft and gear wheel exhibit differential hardening, wherein both are manufactured from tempered ductile iron (ADI), wherein the hardness of the gear wheel is further increased by local differential thermal treatment during ADI heat treatment and/or by peening, and wherein the friction wear resistance of the gear teeth is increased by application of carbide containing coatings (CADI).

5. A crankshaft with combined drive gear wheel, wherein both crankshaft and drive gear wheel are cast as one piece, wherein crankshaft and gear wheel exhibit differential hardening,
wherein both are manufactured from tempered ductile iron (ADI), wherein the hardness of the gear wheel is further increased by local differential thermal treatment during ADI heat treatment and/or by peening, and wherein the friction wear resistance of the gear teeth is increased by application of carbide containing coatings (CADI).

6. A process for manufacturing a crankshaft with combined drive gear wheel, wherein both crankshaft and drive gear wheel are cast as one piece,
wherein a base alloy suitable for tempered ductile iron (ADI) is employed as casting material and heat treated, wherein the heat treatment is controlled locally differentially such that locally the hardness is further increased, and/or
wherein the durability of the gear wheel is locally increased by peening,
and wherein the friction wear resistance of the teeth of the gear wheel is increased by application of carbide containing coatings.
